(19) United States
(12) Patent Application Publication
(10) Pub. No.: US 2025/0231830 A1
(43) Pub. Date: Jul. 17, 2025

(54) BEST HEDGING, UTILIZATION AND VALIDATION OF INFORMATION (BHUVI) MACHINE LEARNING MODEL

(71) Applicant: Kyndryl, Inc., New York, NY (US)

(72) Inventors: Vinay Kumar Gajanana Hegde, Bangalore (IN); Gaurav Shrikisan Satav, Mumbai (IN); Omar Odibat, Cedar Park, TX (US)

(21) Appl. No.: 18/411,161

(22) Filed: Jan. 12, 2024

(51) Int. Cl. G06F 11/07

(52) U.S. Cl. CPC G06F 11/0793; G06F 11/0766

(57) ABSTRACT

A method may include obtaining, by a computing device, an information technology (IT) incident report; obtaining, by the computing device, a set of system details of a system experiencing an IT incident, the IT incident being described by the IT incident report; identifying, by the computing device, a plurality of potential IT incident resolutions; scoring, by the computing device, the plurality of potential IT incident resolutions using a machine learning model, the machine learning model configured to determine a success of the plurality of potential IT incident resolutions; and generating and transmitting, by the computing device and according to the scoring, the plurality of potential IT incident resolutions.

### BACKGROUND

Aspects of the present invention relate generally to information technology (IT) related incidents and, more particularly, to identifying resolutions to IT incidents. Information technology service management (ITSM) relies on various sources containing resolutions, such as an ITSM knowledge base, to identify resolutions to IT incidents.

### SUMMARY

In a first aspect of the invention, there is a computer-implemented method including: obtaining, by a computing device, an information technology (IT) incident report; obtaining, by the computing device, a set of system details of a system experiencing an IT incident, the IT incident being described by the IT incident report; identifying, by the computing device, a plurality of potential IT incident resolutions; scoring, by the computing device, the plurality of potential IT incident resolutions using a machine learning model, the machine learning model configured to determine a success of the plurality of potential IT incident resolutions; and generating and transmitting, by the computing device and according to the scoring, the plurality of potential IT incident resolutions.

In another aspect of the invention, there is a computer program product including one or more computer readable storage media having program instructions collectively stored on the one or more computer readable storage media. The program instructions are executable to: obtain an information technology (IT) incident report; obtain a set of system details of a system experiencing an IT incident, the IT incident being described by the IT incident report; identify a plurality of potential IT incident resolutions; score the plurality of potential IT incident resolutions using a machine learning model, the machine learning model configured to determine a success of the plurality of potential IT incident resolutions; and generate and transmit the plurality of potential IT incident resolutions.

In another aspect of the invention, there is a system including a processor, a computer readable memory, one or more computer readable storage media, and program instructions collectively stored on the one or more computer readable storage media. The program instructions are executable to: obtain an information technology (IT) incident report; obtain a set of system details of a system experiencing an IT incident, the IT incident being described by the IT incident report; standardize the IT incident report and the set of system details for the system; identify a plurality of potential IT incident resolutions; score the plurality of potential IT incident resolutions using a machine learning model, the machine learning model configured to determine a success of the plurality of potential IT incident resolutions; and generate and transmit the plurality of potential IT incident resolutions.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment in accordance with aspects of the invention.

FIG. 5 shows a flowchart of an exemplary method in accordance with aspects of the invention.

FIG. 6 shows a flowchart of an exemplary method in accordance with aspects of the invention.

FIG. 7 shows a flowchart of an exemplary method in accordance with aspects of the invention.

### DETAILED DESCRIPTION

Aspects of the present invention relate generally to an IT incident report and resolution identification, and, more particularly, to an IT incident report and resolution identification based on ITSM knowledge base or original equipment manufacturer (OEM) resolution guidance as well as non-ITSM knowledge base or non-original equipment manufacturer (OEM) resolution guidance. According to aspects of the present invention, a system is disclosed for identifying resolutions to IT incidents including hedging, utilization, and validation of resolution information from a variety of channels via a machine learning model including a model having a best hedging, utilization, and validation of information (BHUVI) model and ranking layer. Hedging may include collecting system details from an external system where an IT incident has occurred as well as IT incident information retrieved from third-party sources such as social media platforms, technological blogs, videos, posts, tutorials, forums, etc. Utilization may include using system details collected from an external system to build and train a BHUVI model and ranking layer. System details collected from an external system may be validated by comparing the system details to known system conditions and configurations, as well as IT incident information retrieved from third-party sources. In embodiments, the system may identify the best available resolutions corresponding to an affected system environment experiencing an IT incident by gathering resolution information from various data sources such as social media. In embodiments, the system may predict the relative success of candidate resolutions from channel data sourced from social media platforms, technological blogs, videos, posts, tutorials, forums, etc. In further embodiments, the system may determine success rates of candidate resolutions and, in some examples, automate implementation of a candidate resolution based on the success rate. In this manner, implementations of the invention identify an IT incident, identify computer environmental factors (such as computer hardware, operating software, and applications), identify potential IT incident resolutions; generate a score for each resolution using a machine learning model based on computer environmental factors; and transmit the score such as to an incident manager user's device.

According to an embodiment, a method for predicting the success of a potential IT incident resolution may include obtaining an IT incident report; obtaining a set of system details of a system experiencing an IT incident, the IT incident being described by the IT incident report; standardizing the IT incident report and the set of system details for the system; identifying, in response to the standardizing, a plurality of potential IT incident resolutions; scoring the plurality of potential IT incident resolutions using a machine learning model including a BHUVI ranking layer, the machine learning model configured to predict the success of the plurality of potential IT incident resolutions; and presenting, according to the scoring, the plurality of potential IT incident resolutions to a user.

According to an embodiment, a method for predicting the success of a potential IT incident resolution may include scoring including evaluating, for at least a subset of the plurality of potential IT incident resolutions best hedging, utilization, and validation of resolution information.

According to an embodiment, a method for predicting the success of a potential IT incident resolution may include simulating an application including at least the subset of the plurality of potential IT incident resolutions to the system; determining a second subset of the plurality, the second subset including potential IT resolutions that resolved the IT incident during the simulation; and generating, based on simulations of the second subset, an automated application recommendation for the second subset, according to the scoring; and presenting the scored automated application recommendation to the user.

According to an embodiment, a method for predicting the success of a potential IT incident resolutions may include receiving, from the user, confirmation to proceed with automatic application of at least one potential IT incident resolution of the second subset; and in response to the receiving, executing the automatic application.

According to embodiments, the steps of scoring, by the computing device, a plurality of potential IT incident resolutions using a machine learning model, such as a BHUVI model described herein, including a ranking layer, the machine learning model configured to predict the relative success of the plurality of potential IT incident resolutions; and generating and transmitting, by the computing device and according to the scoring of the predictions, the plurality of potential IT incident resolutions are computer-based and cannot be performed by “pen and paper” nor can they be performed solely in the human mind. Implementing a machine learning model including a ranking layer configured to predict the success of the plurality of potential IT incident resolutions based on identified computer environmental factors (such as computer hardware, operating software, and applications), and generating a score for each resolution using a machine learning model based on computer environmental factors are all, by definition, performed by a computer implementing a machine learning model having a ranking layer configured to rank incident resolution data based on channel data sentiment i.e., social sentiment associated with channel data. As a nonlimiting example, a resolution having a simulation success score of 95 out of 100 indicates a high likelihood of success in resolving the relevant IT incident. Identified errors may also be used in query augmentation to augment identified IT incidents with categorization tagging of errors relating to the resolution simulated for a particular IT incident. In this way, identified errors may be used to identify new resolutions less likely to experience errors in a simulation or real-world application. A simulation success score may also be determined based on the severity or number of identified errors in a simulation conducted on a physical computing device, a virtual machine, or a container-based system.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

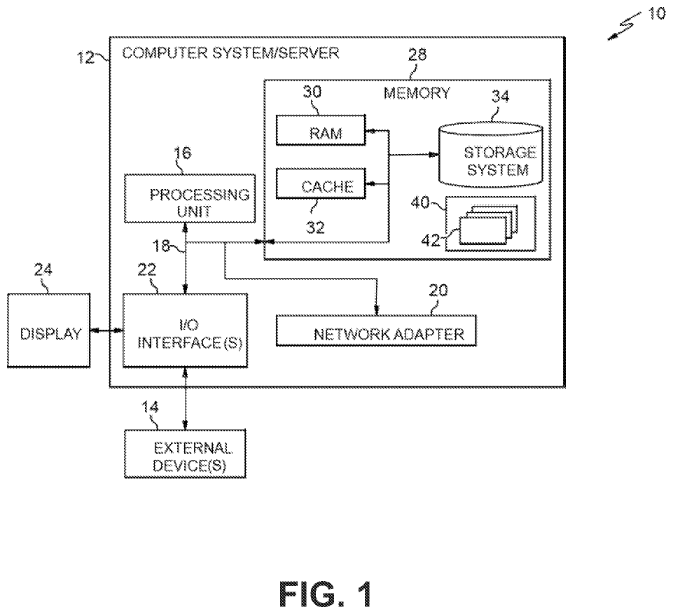

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

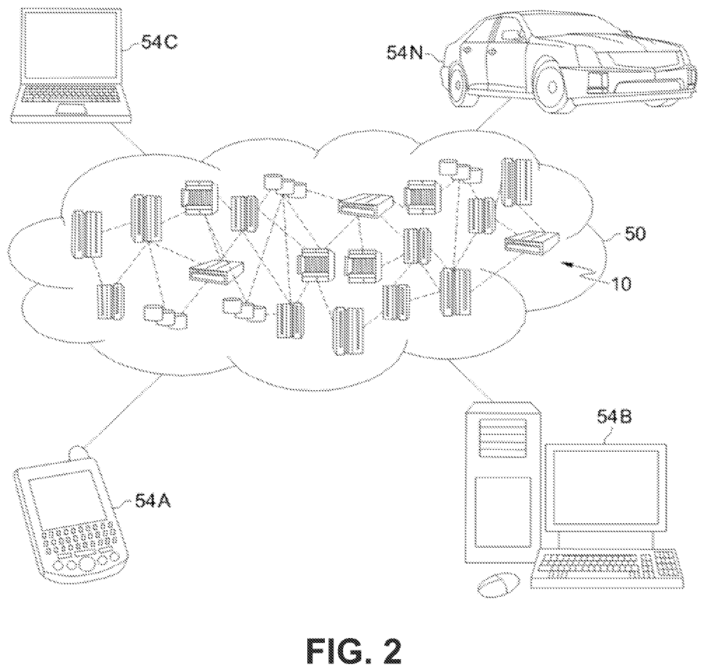

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

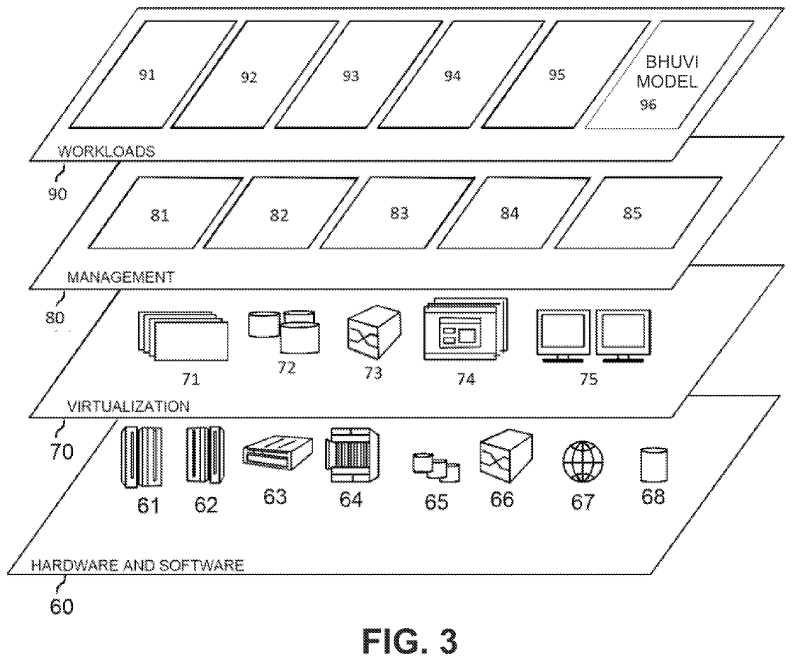

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and BHUVI model 96.

Implementations of the invention may include a computer system/server 12 of FIG. 1 in which one or more of the program modules 42 are configured to perform (or cause the computer system/server 12 to perform) one of more functions of the BHUVI model 96 of FIG. 3. For example, the one or more of the program modules 42 may be configured to: obtain an IT incident report; obtain a set of system details of a system experiencing an IT incident, the IT incident being described by the IT incident report; standardize the IT incident report and the set of system details for the system; identify, in response to the standardizing, a plurality of potential IT incident resolutions; score the plurality of potential IT incident resolutions using a machine learning model, such as a BHUVI model including a ranking layer, the machine learning model configured to predict the success of the plurality of potential IT incident resolutions; and generate and transmit, according to the scoring of the predictions, the plurality of potential IT incident resolutions to a user. The one or more program modules 42 may further be configured to: simulate an application and a subset of a plurality of potential IT incident resolutions to a system; determine a second subset of the plurality, the second subset including potential IT resolutions that resolved the IT incident during the simulation of the application; and generate, based on simulations of the second subset, an automated resolution recommendation for the second subset, according to the scoring; and generate and transmit the scored automated application recommendation to the user. In some embodiments, the system may execute the automated resolution.

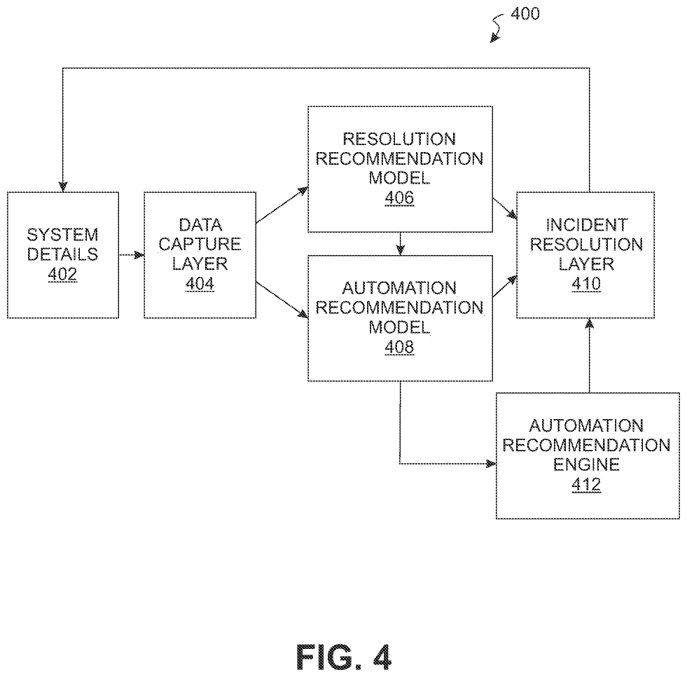

FIG. 4 shows a block diagram of an exemplary environment in accordance with aspects of the invention. In embodiments, the environment includes an incident report identified or received by the system 400. In embodiments, the system 400 comprises at least a data capture layer 404, a resolution recommendation model 406, an automation recommendation model 408, an incident resolution layer 410, and an automation recommendation engine 412, each of which may comprise one or more program modules such as program modules 42 described with respect to FIG. 1. The system 400 may retrieve a set of system details 402 of an external system or device experiencing an IT incident, the IT incident being described by the IT incident report, such as by retrieving external system details stored in a database by the system. In embodiments, the external system or device experiencing an IT incident is separate and distinct from system 400. The data capture layer 404 may be configured to gather data relating to the computer environment experiencing an IT incident as well as data relating to the IT incident from sources such as ITSM and OEM databases, technology information repositories, forums, blogs, social media platforms, etc. Gathered data may be input into a resolution recommendation module 406 configured to arrange resolutions based on sentiment, e.g., resolutions that have received high user “likes,” “shares,” etc. The resolution recommendation module 406 generates a likelihood of a success score for each resolution based on applicability to the computer environment experiencing the IT incident. According to some embodiments, resolutions identified as directly applicable to the computer environment are based on the system details 402 and also may be identified via the automation recommendation model that compares system details 402 to computer environment details identified in a resolution. Automation recommendation model 408 may recommend automated IT incident resolution via an automation recommendation engine 412, which may be configured to simulate resolutions in a virtual environment similar to the external system experiencing an IT incident. Automation recommendation engine 412 may generate a virtual environment having the same details as the system details 402 as the external system experiencing an IT incident and deploy the resolution in the virtual environment to identify potential errors in the resolution. The resolution recommendation model 406, the automation recommendation model 408, and the automation recommendation engine 412 may be in operable communication with an incident resolution layer 410. In particular, the incident resolution layer 410 may receive recommended resolutions, recommendations for automated resolutions, and generated scores associated with the likelihood of success of a particular resolution to be reviewed by a user. System 400 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

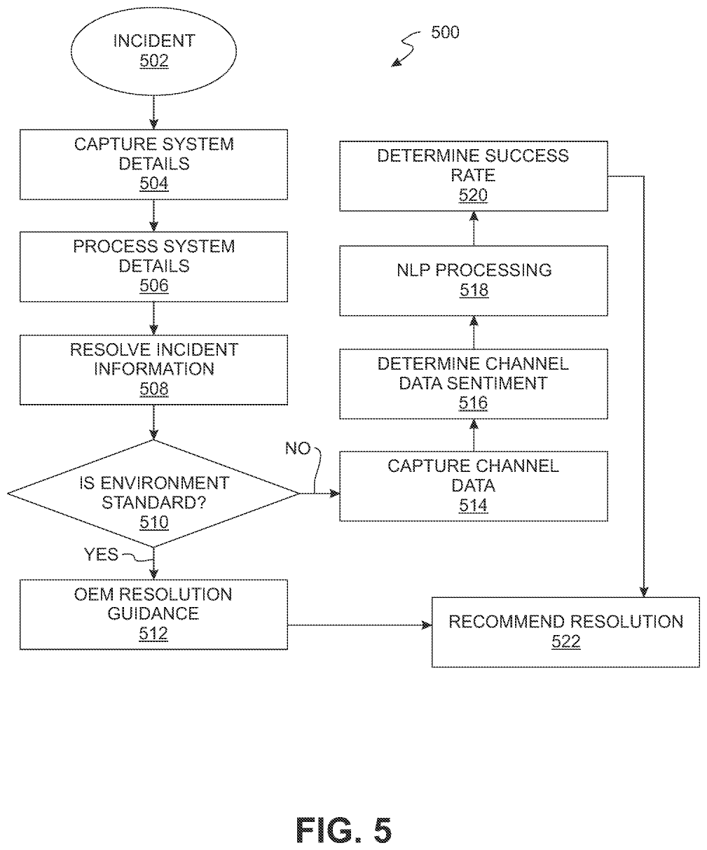

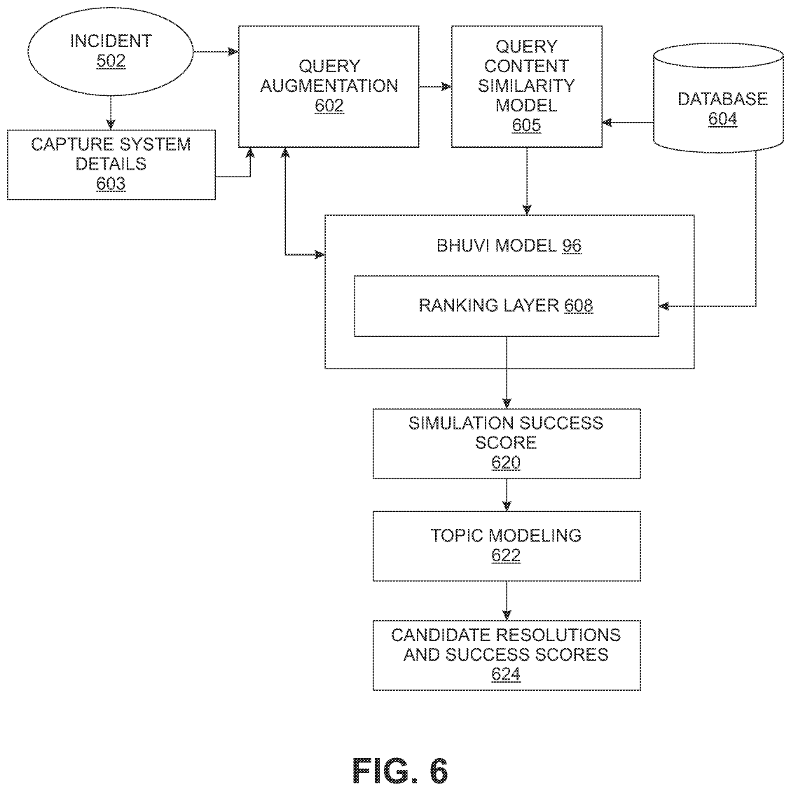

FIG. 5 shows a flowchart of an exemplary method in accordance with aspects of the present invention. Steps of the method may be carried out in the environment of FIG. 4 and are described with reference to elements depicted in FIG. 4. At step 502, the system 500 may receive or identify, via data capture layer 404, an IT incident in an incident report e.g., a crash report relating to the failure of an operating system in an external system or device when performing a particular task. In step 504, the system 500 may be configured to capture the external computer environment system details via the data capture layer 404 as in FIG. 4 by retrieving external operating system details, hardware details, applications running at the time of the incident, and the like from a database. At step 506, the system 500 may process captured external system details via the data capture layer 404 as in FIG. 4 including identifying specific applications, processes, system alerts, user permissions, system settings, and configurations and comparing them to an incident report associated with step 502. As a nonlimiting example, step 506 may identify limited computer resource availability immediately prior to an application crash or error in a computer environment. At step 508, the system 500 may resolve incident information by filtering out incident report data and external system details with low or zero relevance to the IT incident identified by an incident report via the data capture layer 404 as in FIG. 4. At step 510, the system 500 may use external system details to identify if the computer environment is a standard environment (i.e., includes the most up-to-date version of the operating system, application, or tool) for which a resolution is sought, via the data capture layer 404 as in FIG. 4. In response to determining that the computer environment is a standard environment, at step 512, the system 500 may retrieve the OEM recommended resolution guidance for the identified IT incident via resolution recommendation module 406 and automation recommendation model 508 as in FIG. 4. In some embodiments, OEM-recommended resolution guidance may include a recommended resolution that may be automated, as in step 522, via automation recommendation model 508 as in FIG. 4, where the computer environment system details are identical to the computer environment system details associated with the OEM-recommended resolution guidance. For example, in step 510, the system 500 may determine that the computer environment experiencing an IT incident is an “off the shelf” pre-built computing device, such as a consumer or business laptop, by retrieving system details 504 and comparing them to the OEM specifications for the laptop and any pre-installed operating system and applications. In embodiments, the system 500 may standardize the IT incident report and the set of system details 504 for the external system into a format comparable to match the OEM specifications. Standardized IT incident report system details may be comparable to OEM specification standards. A standard environment is present when the system details 504 match the OEM specifications. In response to determining that the computer environment is a non-standard environment, at step 514, the system 500 gathers channel data, via data capture layer 404 as in FIG. 4, relating to the computer environment experiencing an IT incident as well as data relating to the IT incident from sources such as ITSM and OEM databases, technology information repositories, forums, blogs, social media platforms, etc. Channel data may be captured via application programming interface (API) integration, agents, scripts, ports, covering system logs, metrics, events, text, image, audio, video, augmented or virtual sessions, documents, or generated content. In step 516, the system 500 may determine channel data sentiment via a BHUVI model including a ranking layer by ranking channel data based on a user interaction or sentiment with channel data, high user “likes,” “shares,” reviews, etc. In step 518, the system 500 may perform natural language processing via the BHUVI model including a ranking layer of channel data sentiment to further refine the ranking of available resolutions. In particular, step 518 may include hedging potential resolutions based on a relative reliability or sentiment of the channel data resolutions. Step 518 may also include utilization and validation potential resolutions based on relative reliability or sentiment of the channel data resolutions are derived from. Ranking and sentiment may also be based on the relevance of channel data with respect to an IT incident or corresponding incident report. Resolutions may include text, audio, video, or other formats. In step 520, the system 500 may determine and output predicted success rates for one or more resolutions to the IT incident via the BHUVI model including a ranking layer. Calculation of success rates by the BHUVI model includes a ranking layer in the description of FIG. 6. In step 522, the system 500 may transmit recommended resolutions, which may also include OEM recommended resolution guidance as in step 512, to a user device.

FIG. 6 shows a flowchart of an exemplary method in accordance with aspects of the present invention. Steps of the method may be carried out in the environment of FIG. 4 and are described with reference to elements depicted in FIG. 1, FIG. 4, and FIG. 5. At step 502, the system 600 may receive an IT incident. At step 603, the system 500 may be configured to capture the external system details via the data capture layer 404 as in FIG. 4. In particular, the systems details may include operating system details, hardware details, applications running at the time of the incident, etc. At step 602, an incident report including the identified IT incident may be augmented with categorization tagging of the report or the IT incident via query augmentation. Categorization tagging may include tagging specific applications or hardware in an incident report that may be correlated, via the query content similarity model 605, to other incident reports or channel data to rank channel data via the BHUVI model 96 including a ranking layer 608. Query content similarity model 605 may include an embedding model configured to group channel data based on similarity. Query content similarity model 605 may also include a similarity model configured to determine how similar channel data is. In embodiments, query content similarity model 605 may group channel data based on similarity using a k-means clustering algorithm. Incident reports and channel data may be stored in database 604. In embodiments, database 604 corresponds with storage system 34 in FIG. 1. Incident resolutions within channel data may be identified by the query content similarity model 605 based on the embedding and similarity models and communicated to a BHUVI model 96 including a ranking layer 608 configured to rank channel data based on social sentiment, extract incident resolution steps from the channel data, and simulate the incident resolution steps in a virtual environment to identify potential errors when an incident resolution is applied to resolve an IT incident. At step 620, a simulation success score may be determined based on the severity or number of identified errors in a simulation. Identified errors may be used in query augmentation, step 602, to augment identified IT incidents with categorization tagging of errors relating to the resolution simulated for a particular IT incident. In step 622, topic modeling may be performed on candidate resolutions via latent Dirichlet allocation (LDA) or neural topic modeling (NTM) to further filter candidate resolutions based on relevance to an IT incident. In step 624, candidate resolutions and their corresponding success scores may be communicated to a user, such as via display in a user interface on a computing device.

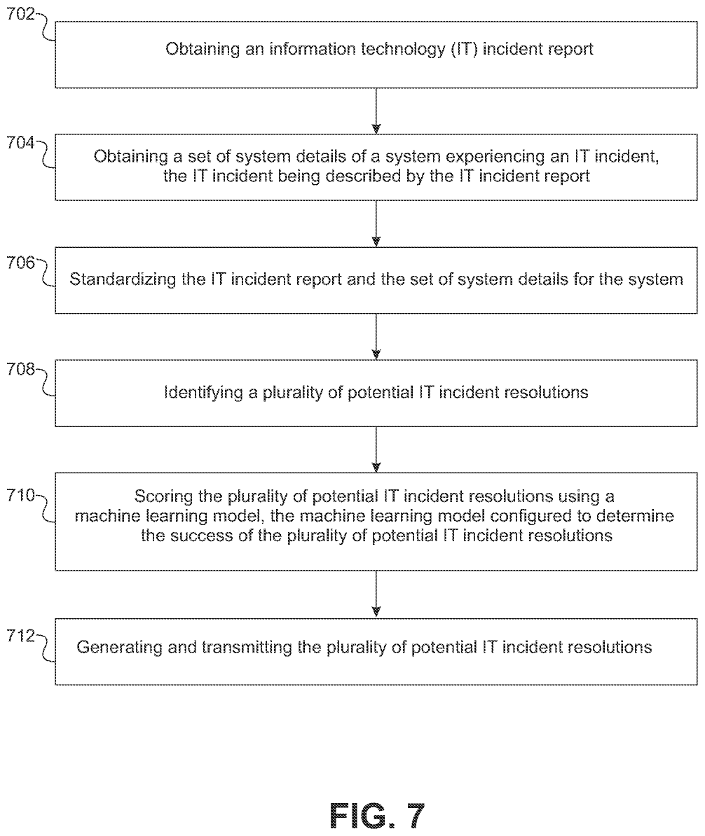

FIG. 7 shows a flowchart of an exemplary method in accordance with aspects of the present invention. Step 702 may include obtaining, by a computing device, an information technology (IT) incident report, such as from a database via data capture layer 404 in FIG. 4. Step 704 may include obtaining, by the computing device, a set of system details of an external system experiencing an IT incident via data capture layer 404 in FIG. 4, the IT incident being described by the IT incident report. The set of system details may be obtained from the system or from a database. Step 706 may include standardizing, by the computing device, the IT incident report and the set of system details for the system into a format comparable to match formatting OEM specifications, such as via query augmentation 602 or query content similarity model 605 in FIG. 6. Step 708 may include identifying, by the computing device and in response to the standardizing, a plurality of potential IT incident resolutions within channel data via a BHUVI model 96 including a ranking layer 608 in FIG. 6. Identifying the plurality of potential IT incident resolutions within channel data may include ranking channel data based on user interaction or sentiment with channel data, high user “likes,” “shares,” reviews, and the like via ranking layer 608 in FIG. 6 and step 516 in FIG. 5. Ranking and sentiment may be based on the relevance of channel data with respect to an IT incident or corresponding incident report. Step 710 may include scoring, by the computing device, the plurality of potential IT incident resolutions using a machine learning model, the machine learning model configured to determine the success of the plurality of potential IT incident resolutions, such as in a simulation, via step 620 in FIG. 6. Step 712 may include generating and transmitting, by the computing device and according to the scoring of the predictions, the plurality of potential IT incident resolutions, via incident resolution layer 410 in FIG. 4.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
obtaining, by a computing device, an information technology (IT) incident report;
obtaining, by the computing device, a set of system details of a system experiencing an IT incident, the IT incident being described by the IT incident report;
identifying, by the computing device, a plurality of potential IT incident resolutions;
scoring, by the computing device, the plurality of potential IT incident resolutions using a machine learning model, the machine learning model configured to determine a success of the plurality of potential IT incident resolutions; and
generating and transmitting, by the computing device and according to the scoring, the plurality of potential IT incident resolutions.

2. The method of claim 1, wherein the obtaining the information technology (IT) incident report comprises obtaining the IT incident report from an external system, and the identifying the plurality of potential IT incident resolutions comprise using a best hedging, utilization, and validation of information (BHUVI) model comprising a ranking layer to identify potential IT incident resolutions within channel data.

3. The method of claim 2, wherein the scoring the plurality of potential IT incident resolutions using a machine learning model comprises using the BHUVI model comprising the ranking layer to generate a success score indicative of sentiment of the channel data.

4. The method of claim 2, further comprising simulating a potential IT incident resolution of the plurality of potential IT incident resolutions in a virtual environment.

5. The method of claim 4, further comprising detecting errors within a simulation of the potential IT incident resolution.

6. The method of claim 5, wherein the scoring the plurality of potential IT incident resolutions using the machine learning model utilizes relative success of the simulation of the potential IT incident resolution.

7. The method of claim 6, further comprising:
standardizing, by the computing device, the IT incident report and the set of system details for the system;
generating a success score of each of the incident resolutions within the plurality of potential IT incident resolutions; and
updating the success score of each of the incident resolutions based on a relative success of an implementation each of the incident resolutions.

8. The method as in claim 1, further comprising filtering the plurality of potential IT incident resolutions based on relevance to the IT incident report via latent Dirichlet allocation (LDA).

9. The method of claim 1, further comprising filtering the plurality of potential IT incident resolutions based on relevance to the IT incident report via neural topic modeling (NTM).

10. A computer program product comprising one or more computer readable storage media having program instructions collectively stored on the one or more computer readable storage media, the program instructions executable to:
obtain an information technology (IT) incident report;
obtain a set of system details of a system experiencing an IT incident, the IT incident being described by the IT incident report;
identify a plurality of potential IT incident resolutions;
score the plurality of potential IT incident resolutions using a machine learning model, the machine learning model configured to determine a success of the plurality of potential IT incident resolutions; and
generate and transmit the plurality of potential IT incident resolutions.

11. The computer program product of claim 10, wherein the obtaining the information technology (IT) incident report comprises obtaining the IT incident report from an external system, and the identifying the plurality of potential IT incident resolutions comprise using a best hedging, utilization, and validation of information (BHUVI) model comprising a ranking layer to identify potential IT incident resolutions within channel data.

12. The computer program product of claim 11, wherein the scoring the plurality of potential IT incident resolutions using a machine learning model comprises using the BHUVI model comprising the ranking layer to generate a success score indicative of sentiment of the channel data.

13. The computer program product of claim 12, wherein the program instructions are further executable to: simulate a potential IT incident resolution of the plurality of potential IT incident resolutions in a virtual environment.

14. The computer program product of claim 13, wherein the program instructions are further executable to: detect errors within a simulation of the potential IT incident resolution.

15. The computer program product of claim 14, wherein the scoring the plurality of potential IT incident resolutions using the machine learning model utilizes relative success of the simulation of the potential IT incident resolution.

16. The computer program product of claim 15, wherein the program instructions are executable to:
standardize the IT incident report and the set of system details for the system;
generate a success score of each of the incident resolutions within the plurality of potential IT incident resolutions; and
update the success score of each of the incident resolutions based on relative success of an implementation each of the incident resolutions.

17. The computer program product of claim 16, wherein the program instructions are further executable to: automate an implementation of a resolution with the plurality of potential IT incident resolutions based on the success score.

18. The computer program product of claim 16, wherein the program instructions are further executable to: sort each of the resolutions within the plurality of potential IT incident resolutions based on the success score.

19. The computer program product of claim 10, wherein the program instructions are further executable to: filter the plurality of potential IT incident resolutions based on relevance to the IT incident report via latent Dirichlet allocation (LDA).

20. A system comprising:
a processor, a computer readable memory, one or more computer readable storage media, and program instructions collectively stored on the one or more computer readable storage media, the program instructions executable to:
obtain an information technology (IT) incident report;
obtain a set of system details of a system experiencing an IT incident, the IT incident being described by the IT incident report;
standardize the IT incident report and the set of system details for the system;
identify a plurality of potential IT incident resolutions;
score the plurality of potential IT incident resolutions using a machine learning model, the machine learning model configured to determine a success of the plurality of potential IT incident resolutions; and
generate and transmit the plurality of potential IT incident resolutions.
